(19) United States
(12) Patent Application Publication
(10) Pub. No.: US 2015/0167352 A1
(43) Pub. Date: Jun. 18, 2015

(54) Locking Apparatus

(71) Applicant: Huawei Technologies Co., Ltd., Shenzhen (CN)

(72) Inventor: Peng Xu, Shenzhen (CN)

(21) Appl. No.: 14/565,848

(22) Filed: Dec. 10, 2014

(30) Foreign Application Priority Data
Dec. 17, 2013 (CN) 201310724664.8

(51) Int. Cl. E05B 55/06; E05B 3/00

(52) U.S. Cl. CPC E05B 55/06; E05B 3/00

(57) ABSTRACT

A locking apparatus is provided that includes a pull handle, a locking member, a resetting apparatus, and a base. The pull handle includes a pulling part and a sliding part, the sliding part includes a slot and a first guiding part, the locking member includes a fixed end and a locking arm, the locking arm includes a second guiding part, and the base includes a groove. The pull handle is slidably disposed in the groove of the base through the sliding part, the resetting apparatus is disposed between the slot of the pull handle and the groove of the base in a sliding direction of the pull handle, and the fixed end of the locking member spans the sliding part of the pull handle and is fastened on the base. The pulling part drives, under force, the resetting apparatus to deform so as to achieve an unlocking effect.

### CROSS-REFERENCE TO RELATED APPLICATION

This application claims priority to Chinese Patent Application No. 201310724664.8, filed on Dec. 17, 2013, which is hereby incorporated by reference in its entirety.

### TECHNICAL FIELD

The present invention relates to a locking apparatus, and in particular, to a fiber connection locking apparatus that is applied to an optoelectronic module in the optical communications field.

### BACKGROUND

As an optical communications product develops toward features of miniaturization, high integration, and a high rate, a locking apparatus that is used for connection between modules in a communications apparatus becomes more popular. These types of modules need to be inserted and removed flexibly, and require that a stable connection state is ensured. Therefore, these types of modules all require a mechanical locking apparatus. Existing locking apparatuses mainly use a structure mode such as a lever or a slide wedge. However, structures of these apparatuses are complex and inconvenient to operate, and due to a large variety of accessories, an assembly process is complex and costs are relatively high.

### SUMMARY

The present invention provides a locking apparatus that features simple design, and can automatically restore after being unlocked.

According to a first aspect, a locking apparatus is provided, where the apparatus includes a pull handle, a locking member, and a base; one end of the locking member is fastened on the base, one end of the pull handle is slidably disposed between the locking member and the base, so as to drive, in a sliding manner, the pull handle to jack up the locking member to enter an unlocked state; and the locking apparatus further includes a resetting apparatus, and the resetting apparatus is disposed between the pull handle and the base, connected to the pull handle and the base, and configured to restore the locking apparatus from the unlocked state to an initial position.

With reference to the first aspect, in a first possible implementation manner of the first aspect, the locking member includes a fixed end and a locking arm extending from the fixed end, the locking member is fixedly disposed on the base through the fixed end, and the locking arm is suspended above the base in a sliding direction of the pull handle; the pull handle includes a pulling part, a sliding part extending from the pulling part, and a first guiding part disposed at a tail end of the sliding part, the pull handle is slidably disposed on the base through the sliding part, and the pulling part of the pull handle is located outside the base; when the pulling part of the pull handle drives, under the action of external force, the sliding part to move from an original position of the sliding part toward a direction that deviates from the base, the first guiding part abuts against the locking arm of the locking member and jacks up the locking arm to enter the unlocked state; one end of the resetting apparatus is connected to the sliding part of the pull handle, and the other end is connected to the base; and when the pulling part of the pull handle drives, under the action of the external force, the sliding part to move from the original position of the sliding part toward the direction that deviates from the base, the resetting apparatus deforms, and when the external force disappears, restores to an original state and drives the pull handle to restore to an initial position of the pull handle.

With reference to the first possible implementation manner of the first aspect, in a second possible implementation manner of the first aspect, the locking arm of the locking member includes a second guiding part; and when the pulling part of the pull handle drives, under the action of the external force, the sliding part to move from the original position of the sliding part toward the direction that deviates from the base, the first guiding part abuts against the second guiding part of the locking member to jack up the locking arm to enter the unlocked state.

With reference to the second possible implementation manner of the first aspect, in a third possible implementation manner of the first aspect, the first guiding part extends from the sliding part of the pull handle toward a direction of the locking arm of the locking member and forms a first guiding surface at a tail end of the first guiding part.

With reference to the third possible implementation manner of the first aspect, in a fourth possible implementation manner of the first aspect, the second guiding part extends from the locking arm of the locking member toward a direction in which the sliding part of the pull handle is located, and forms, at a tail end of the second guiding part, a second guiding surface that can abut against the first guiding surface of the first guiding part of the pull handle.

With reference to the fourth possible implementation manner of the first aspect, in a fifth possible implementation manner of the first aspect, the first guiding surface is a sloping surface, and the second guiding surface is an arc surface; or the first guiding surface is an arc surface, and the second guiding surface is a sloping surface; or the first guiding surface is a sloping surface, and the second guiding surface is a sloping surface that is complementary to the first guiding surface; or the first guiding surface is an arc surface, and the second guiding surface is an arc surface that is complementary to the first guiding surface.

With reference to the first possible implementation manner of the first aspect or the second possible implementation manner of the first aspect, in a sixth possible implementation manner of the first aspect, the first guiding part consists of a cylinder, and a cylindrical surface that is of the cylinder and faces the locking arm is overall higher than the sliding part.

With reference to the second possible implementation manner of the first aspect, in a seventh possible implementation manner of the first aspect, the second guiding part is a U-shaped structure that protrudes from the locking arm toward a direction of sliding part of the pull handle.

With reference to the first possible implementation manner of the first aspect, in an eighth possible implementation manner of the first aspect, the base further includes a groove, and the sliding part is slidably disposed in the groove of the base.

With reference to the eighth possible implementation manner of the first aspect, in a ninth possible implementation manner of the first aspect, the groove has a groove stopper at an end that is on the base and close to a direction in which the pull handle slides away from the base; the sliding part of the pull handle has a slot, and the slot has a slot stopper at an end close to the first guiding part; and the resetting apparatus is disposed between the groove stopper and the slot stopper.

With reference to the eighth possible implementation manner of the first aspect or the ninth possible implementation manner of the first aspect, in a tenth possible implementation manner of the first aspect, a spacing groove is formed in the groove in a position corresponding to the first guiding part of the pull handle, and the first guiding part of the pull handle is located in the spacing groove, where a size of the spacing groove in the sliding direction of the pull handle is greater than a size of the first guiding part in the sliding direction of the pull handle, a size of the spacing groove in a direction perpendicular to the sliding direction of the pull handle is greater than a size of the groove adjacent to the spacing groove, and greater than a size of the first guiding part of the pull handle in a direction perpendicular to the sliding direction of the pull handle, and both the sliding direction of the pull handle and the direction perpendicular to the sliding direction of the pull handle use a same plane as a reference.

With reference to any manner of the first possible implementation manner of the first aspect to the tenth possible implementation manner of the first aspect, in an eleventh possible implementation manner of the first aspect, the locking arm of the locking member further includes a locking hook, the locking hook is located at a tail end of the locking arm, and the locking hook extends in a same extending direction as the second guiding part from the locking arm of the locking member toward the direction in which the sliding part of the pull handle is located.

With reference to any manner of the first aspect to the tenth possible implementation manner of the first aspect, in a twelfth possible implementation manner of the first aspect, the resetting apparatus is an elastic member.

With reference to the twelfth possible implementation manner of the first aspect, in a thirteenth possible implementation of the first manner, the elastic member is a spring or an elastic sheet.

The locking apparatus provided in the present invention implements, by using a resetting apparatus, automatic resetting of the locking apparatus after being unlocked, so as to facilitate use of the locking apparatus. In addition, in the locking apparatus, a sliding displacement between a guiding surface of a locking member and a guiding surface of a pull handle is used to jack up a locking arm of the locking member, so as to achieve an unlocking purpose. A principle of the locking apparatus is simple, a function structure is simple, manufacture is convenient, and assembly is simple, so that product costs can be lowered and production efficiency can be improved.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic diagram of assembly of a locking apparatus according to the present invention;

FIG. 2 is a detailed schematic diagram of assembly of a locking apparatus according to the present invention;

FIG. 3 is an outline diagram of a base of a locking apparatus according to the present invention;

FIG. 4 is an outline diagram of a pull handle of a locking apparatus according to the present invention;

FIG. 5 is an outline diagram of a locking member of a locking apparatus according to the present invention;

FIG. 6 is an outline diagram of an elastic member of a locking apparatus according to the present invention;

FIG. 7 is a complete assembly diagram of a locking apparatus according to the present invention;

FIG. 8 is a diagram of an implementation process of a function of a locking apparatus according to the present invention;

FIG. 9 is a schematic diagram of an implementation manner of a locking apparatus according to the present invention; and

FIG. 10 is a schematic diagram of another implementation manner of a locking apparatus according to the present invention.

### DESCRIPTION OF EMBODIMENTS

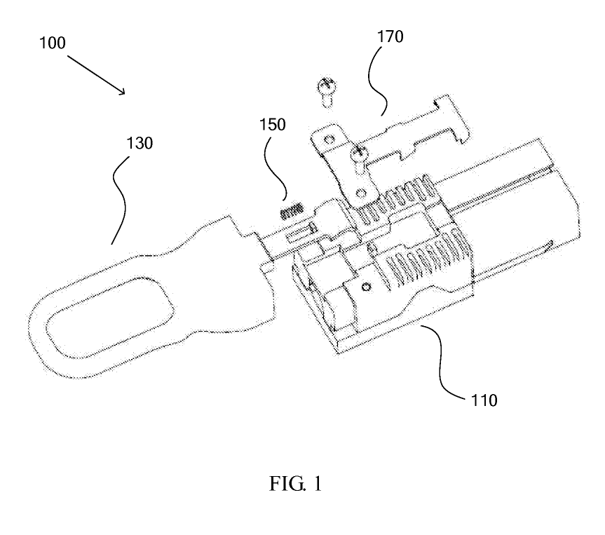

Referring to FIG. 1, an embodiment of the present invention provides a locking apparatus 100. The apparatus 100 includes a pull handle 130, a locking member 170, and a base 110; one end of the locking member 170 is fastened on the base 110, one end of the pull handle 130 is slidably disposed between the locking member 170 and the base 110, so as to drive, in a sliding manner, the pull handle 130 to jack up the locking member 170 to enter an unlocked state; and the locking apparatus 100 further includes a resetting apparatus 150, and the resetting apparatus 150 is disposed between the pull handle 130 and the base 110, connected to the pull handle 130 and the base 110, and configured to restore the locking apparatus 100 from the unlocked state to an initial position.

The locking apparatus 100 provided in this embodiment of the present invention implements, by using a resetting apparatus 150, automatic resetting of the locking apparatus 100 after being unlocked, so as to facilitate use of the locking apparatus 100. In addition, in the locking apparatus 100, a sliding displacement between a locking member 170 and a pull handle 130 is used to jack up the locking member 170, so as to achieve an unlocking purpose. A principle of the locking apparatus 100 is simple, a function structure is simple, manufacture is convenient, and assembly is simple, so that product costs can be lowered and production efficiency can be improved.

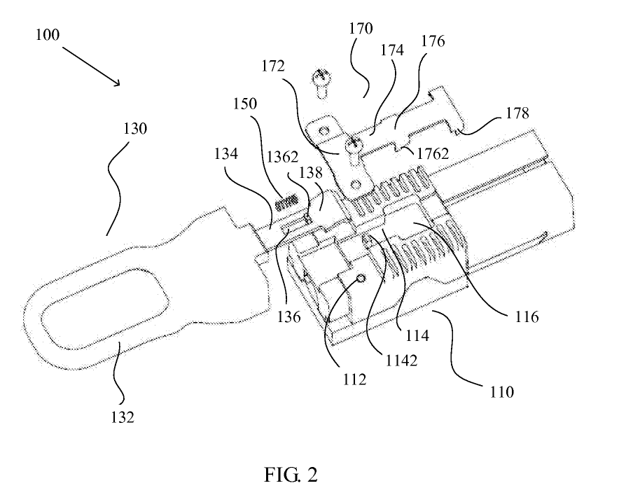

Referring to FIG. 2, an embodiment of the present invention provides a locking apparatus 100. The locking apparatus 100 includes a base 110, a pull handle 130, a resetting apparatus 150, and a locking member 170.

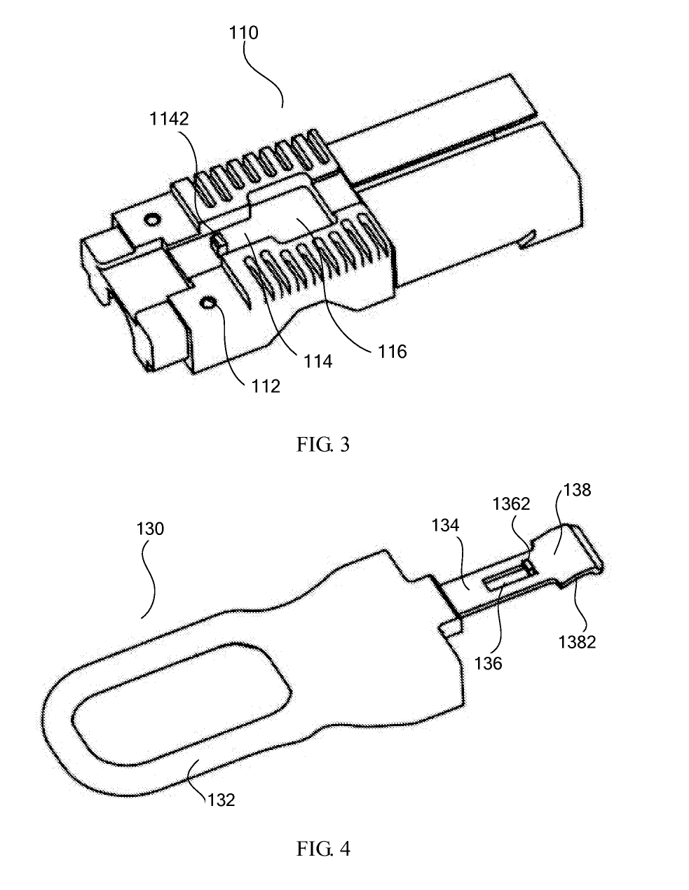

Referring to FIG. 3, the base 110 includes a base fixed end 112, a groove 114, and a groove stopper 1142.

Referring to FIG. 4, the pull handle 130 includes a pulling part 132, a sliding arm 134, and a first guiding part 138.

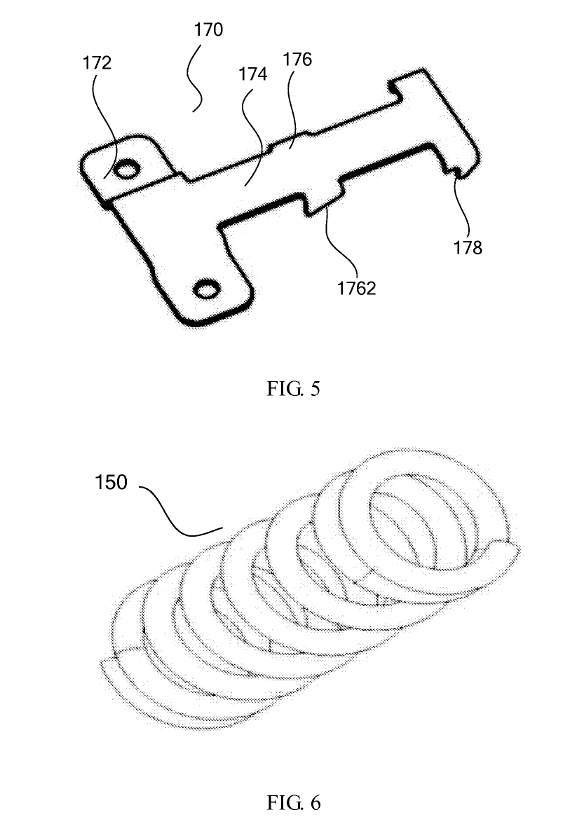

Referring to FIG. 5, the locking member 170 includes a lock member fixed end 172, a locking arm 174, and a second guiding part 176.

The locking apparatus 100 provided in the present invention is configured to process unlocking and resetting between modules. The locking apparatus 100 includes the base 110, the resetting apparatus 150, the pull handle 130, and the locking member 170. As shown in FIG. 2, FIG. 2 is a schematic diagram of assembly of a locking apparatus according to the present invention. The locking member 170 includes the lock member fixed end 172 and the locking arm 174 extending outwards from the fixed end 172. The pull handle 130 includes the pulling part 132 and the sliding part 134 extending from the pulling part 132. The lock member fixed end 172 of the locking member 170 spans the sliding part 134 of the pull handle 130 and is fastened on the base 110, the sliding part 134 of the pull handle 130 is slidably disposed between the locking member 170 and the base 110, and the pulling part 132 of the pull handle 130 is located outside the base 110. When the pulling part 132 is pulled out in a direction that deviates from the base 110, to drive the sliding part 134 to slide, so as to enable the sliding part 134 to jack up the locking arm 174 of the locking member 170 to enter an unlocked state. In this embodiment, the locking apparatus 100 further includes the resetting apparatus 150, and the resetting apparatus 150 is disposed between the sliding part 134 of the pull handle 130 and the base 110 and is connected to the sliding part 134 and the base 110, so as to drive the pull handle 132 to slide toward a direction facing the base 110 to restore to an initial state, so that the locking apparatus 100 restores from the unlocked state to an initial position.

Further, as shown in FIG. 3, the base 110 includes the base fixed end 112 and the groove 114, and the base fixed end 112 of the base 110 is configured to dispose the locking member 170. The groove 114 is configured to dispose the sliding part 134 of the pull handle 130 and the resetting apparatus 150.

The sliding part 134 extending from the pulling part 132 extends or reverses at a tail end of the sliding part 134 toward an inclined top direction that deviates from the sliding part 134, to form the first guiding part 138, and optionally, a sloping surface formed by the extending or an arc surface formed by the reversing is a first guiding surface 1382. Optionally, the locking arm 174 includes the second guiding part 176, and the second guiding part 176 is a part that is formed by extending of the locking arm 174 toward a direction in which the sliding part 134 of the pull handle 130 is located, and can abut against the first guiding part 138. Further, optionally, the second guiding part 176 forms, at a tail end that is of the second guiding part 176 and faces the extending of the sliding part 134, a second guiding surface 1762 that can abut against the first guiding surface 1382. The sliding part 134 of the pull handle 130 is slidably disposed between the locking member 170 and the base 110, and the pulling part 132 of the pull handle 130 is located outside the base 110; and when the pulling part 132 drives, under the action of external force, the sliding part 134 to move from an original position of the sliding part 134 toward a direction that deviates from the base 110, the first guiding part 138 abuts against the second guiding part 176 on the locking arm 174. Optionally, that the first guiding part 138 abuts against the second guiding part 176 on the locking arm 174 may be as follows. The first guiding surface 1382 of the first guiding part 138 abuts against the second guiding surface 1762 of the second guiding part 176. As the sliding part 134 moves, the first guiding part 138 and the second guiding part 176 gradually generate a displacement during the abutting and jack up the locking arm 174 through the second guiding part 176, so as to enter the unlocked state. One end of the resetting apparatus 150 is connected to the sliding part 134, and the other end corresponding to the one end is connected to the base 110. When the pulling part 132 drives, under the action of the external force, the sliding part 134 to move from the original position of the sliding part 134 toward the direction that deviates from the base 110, the sliding part 134 drives the resetting apparatus 150 to deform, and elastic force generated by the deformation corresponds to the external force; and when the external force disappears, the elastic force acts on the resetting apparatus 150, and the resetting apparatus 150 acts on the sliding part 134 connected to the resetting apparatus 150; and when the resetting apparatus 150 restores to an initial state, the sliding part 134 also drives the pull handle 130 to restore to an initial position, so as to complete resetting of the locking apparatus.

Optionally, in this embodiment of the present invention, the first guiding surface 1382 is a sloping surface, the second guiding surface 1762 is an arc surface, and the arc surface of the second guiding surface 1762 is a surface that can abut against the sloping surface of the first guiding surface 1382 and move to generate a displacement; or the first guiding surface 1382 is an arc surface, the second guiding surface 1762 is a sloping surface, and the sloping surface is a surface that can abut against the arc surface and move to generate a displacement; or the first guiding surface 1382 is a sloping surface, and the second guiding surface 1762 is a sloping surface that can abut against the first guiding surface 1382; or the first guiding surface 1382 is an arc surface, and the second guiding surface 1762 is an arc surface that can abut against the first guiding surface 1382. When the pulling part 132 drives, under the action of the external force, the sliding part 134 to move from the original position of the sliding part 134 toward the direction that deviates from the base 110, the first guiding surface 1382 abuts against the second guiding surface 1762. As the sliding part 134 moves, the first guiding surface 1382 and the second guiding surface 1762 gradually generate a displacement during the abutting and jack up the locking arm 174 through the second guiding part 176, so as to enter the unlocked state.

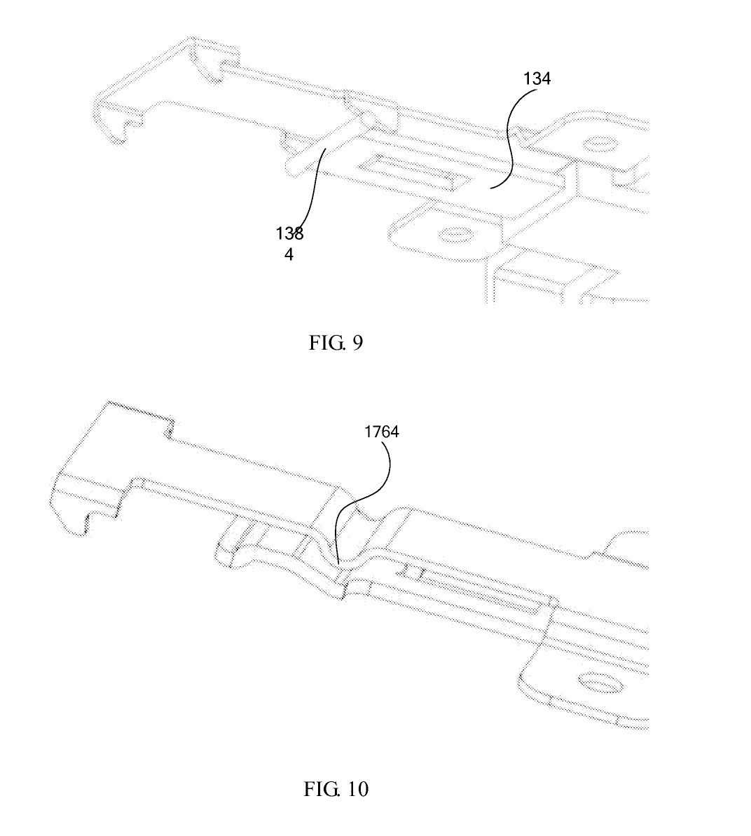

With reference to FIG. 2 and FIG. 9, in another embodiment of the present invention, the sliding part 134 extending from the pulling part 132 forms, at a tail end of the sliding part 134, a guiding cylinder 1384 so as to form the first guiding part 138, and a guiding cylindrical surface that is of the guiding cylinder 1384 and faces the locking arm 174 is overall higher than the sliding part 134. The sliding part 134 of the pull handle 130 is slidably disposed between the locking member 170 and the base 110, and the pulling part 132 of the pull handle 130 is located outside the base 110. When the pulling part 132 drives, under the action of the external force, the sliding part 134 to move from the original position of the sliding part 134 toward the direction that deviates from the base 110, the guiding cylinder 1384 abuts against the locking arm 174 of the locking member 170. As the sliding part 134 moves, the guiding cylinder 1384 gradually generates a displacement from the locking arm 174 during the abutting and gradually jacks up the locking arm 174 so as to enter the unlocked state. One end of the resetting apparatus 150 is connected to the sliding part 134, and the other end corresponding to the one end is connected to the base 110. When the pulling part 132 drives, under the action of the external force, the sliding part 134 to move from the original position of the sliding part 134 toward the direction that deviates from the base 110, the sliding part 134 drives the resetting apparatus 150 to deform, and elastic force generated by the deformation corresponds to the external force; and when the external force disappears, the elastic force acts on the resetting apparatus 150, and the resetting apparatus 150 acts on the sliding part 134 connected to the resetting apparatus 150; and when the resetting apparatus 150 restores to the initial state, the sliding part 134 also drives the pull handle 130 to restore to the initial position, so as to complete resetting of the locking apparatus.

As shown in FIG. 10, optionally, a guiding surface of the second guiding part 176 may further be a U-shaped structure 1764 that protrudes from the locking arm 174 toward a direction of the sliding part 134 of the pull handle 130.

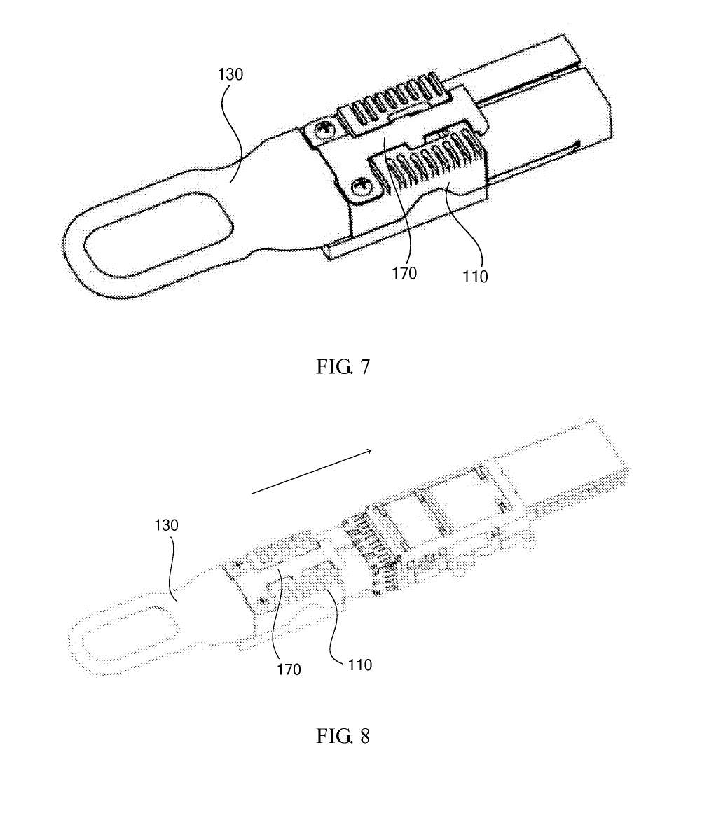

Optionally, with reference to FIG. 1 and FIG. 7, the base 110 further includes the groove 114, and the sliding part 134 is slidably disposed in the groove 114 of the base 110 through the resetting apparatus 150. Optionally, that the sliding part 134 is slidably disposed in the groove 114 of the base 110 through the resetting apparatus 150 includes the following. The groove 114 has the groove stopper 1142 at an end that is on the base 110 and close to a direction in which the pull handle 130 slides away from the base 110. Correspondingly, the sliding part 134 of the pull handle 130 has a slot 136, and the slot 136 has a slot stopper 1362 at an end close to the first guiding part 138; the resetting apparatus 150 is disposed between the groove stopper 1142 and the slot stopper 1362, that is, one end of the resetting apparatus 150 is against the groove stopper 1142, the other end corresponding to the one end is against the slot stopper 1362, the groove stopper 1142 is fixed, the slot stopper 1362 moves along with the sliding part 134 to generate a displacement change relative to the groove stopper 1142, and the displacement change drives the resetting apparatus 150 to deform, so as to implement that the sliding part 134 is slidably disposed in the groove 114 of the base 110 through the resetting apparatus 150, and implement a function of the resetting apparatus 150.

Further, optionally, with reference to FIG. 2 and FIG. 3, this embodiment of the present invention may further include the following. The sliding part 134 is disposed in the groove 114 of the base 110, and correspondingly, a spacing groove 116 is formed in the groove 114 in a position corresponding to the first guiding part 138, and the sliding part 134 is slidably disposed in the spacing groove 116, where a size of the spacing groove 116 in the sliding direction of the pull handle 130 is greater than a size of the first guiding part in the sliding direction of the pull handle 130, a size of the spacing groove 116 in a direction perpendicular to the sliding direction of the pull handle 130 is greater than a size of the groove 114 adjacent to the spacing groove, and greater than a size of the first guiding part 138 in a direction perpendicular to the sliding direction of the pull handle 130, and both the sliding direction of the pull handle 130 and the direction perpendicular to the sliding direction of the pull handle 130 use a same plane as a reference.

Further, optionally, with reference to FIG. 2 and FIG. 5, this embodiment of the present invention may further include the following. As shown in FIG. 5, the locking arm 174 has a locking hook 178 at a tail end of the locking arm 174; and as shown in FIG. 2, the locking hook 178 extends in a same extending direction as the second guiding part 176 from the locking arm 174 toward the direction in which the sliding part 134 of the pull handle 130 is located. That is, when the pulling part 132 drives, under the action of the external force, the sliding part 134 to move from the original position of the sliding part 134 toward the direction that deviates from the base 110, the first guiding surface 1382 abuts against the second guiding surface 1762. As the sliding part 134 moves, the first guiding surface 1382 and the second guiding surface 1762 gradually generate a displacement during the abutting and jack up the locking arm 174 through the second guiding part 176. As the locking arm 174 is jacked up, the locking hook 178 is also jacked up, so that the locking hook 178 is detached from a locked object, and then the locking apparatus enters the unlocked state.

This embodiment of the present invention further includes the following. As shown in FIG. 6, the resetting apparatus 150 is an elastic member, and the elastic member may be a spring shown in FIG. 6, or may be another elastic member that has a similar function, such as an elastic sheet, a plate spring, or a rotary spring.

When the locking apparatus 100 according to the present invention is used, the pulling part 132 drives, under the action of the external force, the sliding part 134 to move from the original position of the sliding part 134 toward the direction that deviates from the base 110, and the first guiding surface 1382 abuts against the second guiding surface 1762. The resetting apparatus 150 is disposed between the groove stopper 1142 and the slot stopper 1362. As the sliding part 134 moves, the slot stopper 1362 and the groove stopper 1142 generate a displacement change to drive the resetting apparatus 150 to deform, so as to drive the first guiding surface 1382 to slide and gradually generate a displacement change between the second guiding surface 1762 and the first guiding surface 1382 during the abutting. During a displacement change process, the second guiding part 176 is gradually jacked up, that is, the locking arm 174 is gradually jacked up. When an accumulated displacement change reaches a specific value, the locking arm 174 drives the locking hook 178 to be jacked up to a highest position, the locking hook 178 is detached from the locked object, and the locking apparatus enters the unlocked state. When the slot stopper 1362 and the groove stopper 1142 generate the displacement change to drive the resetting apparatus 150 to deform, elastic force generated by the deformation corresponds to the external force. When the external force disappears, the elastic force acts on the resetting apparatus 150, and the resetting apparatus 150 acts on the slot stopper 1362 connected to the resetting apparatus 150, and further acts on the sliding part 134. When the resetting apparatus 150 restores to the initial state, the sliding part 134 also drives the pull handle 130 to restore to the initial position, so as to complete resetting of the locking apparatus.

The locking apparatus 100 provided in the present invention implements, by using an elastic member of a resetting apparatus 150, automatic resetting of the locking apparatus 100 after being unlocked, so as to facilitate use of the locking apparatus 100. In addition, in the locking apparatus 100, a sliding displacement between a second guiding surface 1762 and a first guiding surface 1382 is used to jack up a locking arm 174 of a locking member 170, so as to achieve an unlocking purpose. The structure of the locking apparatus is simple, manufacture is convenient, and assembly is simple, so that product costs can be lowered and production efficiency can be improved.

1. A locking apparatus, comprising:
a pull handle;
a locking member;
a base, wherein one end of the locking member is fastened on the base, wherein one end of the pull handle is slidably disposed between the locking member and the base to drive, in a sliding manner, the pull handle to jack up the locking member to enter an unlocked state; and
a resetting apparatus, wherein the resetting apparatus is disposed between the pull handle and the base, connected to the pull handle and the base, and configured to restore the locking apparatus from the unlocked state to an initial position.

2. The locking apparatus according to claim 1, wherein the locking member comprises a fixed end and a locking arm extending from the fixed end, the locking member is fixedly disposed on the base through the fixed end, and the locking arm is suspended above the base in a sliding direction of the pull handle, wherein the pull handle comprises a pulling part, a sliding part extending from the pulling part, and a first guiding part disposed at a tail end of the sliding part, the pull handle is slidably disposed on the base through the sliding part, and the pulling part of the pull handle is located outside the base, wherein when the pulling part of the pull handle drives, under the action of external force, the sliding part to move from an original position of the sliding part toward a direction that deviates from the base, the first guiding part abuts against the locking arm of the locking member and jacks up the locking arm to enter the unlocked state, wherein one end of the resetting apparatus is connected to the sliding part of the pull handle, and the other end is connected to the base, and wherein when the pulling part of the pull handle drives, under the action of the external force, the sliding part to move from the original position of the sliding part toward the direction that deviates from the base, the resetting apparatus deforms, and when the external force disappears, restores to an original state and drives the pull handle to restore to an initial position of the pull handle.

3. The locking apparatus according to claim 2, wherein the locking arm of the locking member comprises a second guiding part, and wherein when the pulling part of the pull handle drives, under the action of the external force, the sliding part to move from the original position of the sliding part toward the direction that deviates from the base, the first guiding part abuts against the second guiding part of the locking member to jack up the locking arm to enter the unlocked state.

4. The locking apparatus according to claim 3, wherein the first guiding part extends from the sliding part of the pull handle toward a direction of the locking arm of the locking member and forms a first guiding surface at a tail end of the first guiding part.

5. The locking apparatus according to claim 4, wherein the second guiding part extends from the locking arm of the locking member toward a direction in which the sliding part of the pull handle is located, and forms, at a tail end of the second guiding part, a second guiding surface that is configured to abut against the first guiding surface of the first guiding part of the pull handle.

6. The locking apparatus according to claim 5, wherein the first guiding surface is a sloping surface, and the second guiding surface is an arc surface.

7. The locking apparatus according to claim 2, wherein the first guiding part comprises a cylinder, and wherein a cylindrical surface that is of the cylinder and faces the locking arm is overall higher than the sliding part.

8. The locking apparatus according to claim 3, wherein the second guiding part is a U-shaped structure that protrudes from the locking arm toward a direction of the sliding part of the pull handle.

9. The locking apparatus according to claim 2, wherein the base further comprises a groove, and the sliding part is slidably disposed in the groove of the base.

10. The locking apparatus according to claim 9, wherein the groove has a groove stopper at an end that is on the base and close to a direction in which the pull handle slides away from the base, wherein the sliding part of the pull handle has a slot, and the slot has a slot stopper at an end close to the first guiding part, and wherein the resetting apparatus is disposed between the groove stopper and the slot stopper.

11. The locking apparatus according to claim 9, wherein a spacing groove is formed in the groove in a position corresponding to the first guiding part of the pull handle, and the first guiding part of the pull handle is located in the spacing groove, wherein a size of the spacing groove in the sliding direction of the pull handle is greater than a size of the first guiding part in the sliding direction of the pull handle, a size of the spacing groove in a direction perpendicular to the sliding direction of the pull handle is greater than a size of the groove adjacent to the spacing groove, and greater than a size of the first guiding part of the pull handle in a direction perpendicular to the sliding direction of the pull handle, and both the sliding direction of the pull handle and the direction perpendicular to the sliding direction of the pull handle use a same plane as a reference.

12. The locking apparatus according to claim 2, wherein the locking arm of the locking member further comprises a locking hook, the locking hook is located at a tail end of the locking arm, and the locking hook extends in a same extending direction as the second guiding part from the locking arm of the locking member toward the direction in which the sliding part of the pull handle is located.

13. The locking apparatus according to claim 1, wherein the resetting apparatus is an elastic member.

14. The locking apparatus according to claim 13, wherein the elastic member is a spring.

15. The locking apparatus according to claim 13, wherein the elastic member is an elastic sheet.

16. The locking apparatus according to claim 5, wherein the first guiding surface is an arc surface, and the second guiding surface is a sloping surface.

17. The locking apparatus according to claim 5, wherein the first guiding surface is a sloping surface, and the second guiding surface is a sloping surface that is complementary to the first guiding surface.

18. The locking apparatus according to claim 5, wherein the first guiding surface is an arc surface, and the second guiding surface is an arc surface that is complementary to the first guiding surface.
